(19) United States
(12) Patent Application Publication
(10) Pub. No.: US 2007/0085762 A1
(43) Pub. Date: Apr. 19, 2007

(54) Method and its device for concealing at least a mark in a number

(75) Inventor: Mu-Hsiang Huang, Hsin Tien City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Prescope Technologies Co., Ltd.

(21) Appl. No.: 11/284,882

(22) Filed: Nov. 23, 2005

(30) Foreign Application Priority Data
Oct. 13, 2005 (TW) 094135643

(51) Int. Cl. G09G 3/04

(52) U.S. Cl. 345/34

(57) ABSTRACT

The present invention provides a method for concealing a mark in a number including the following steps: separating a number into seven segments, concealing at least a mark in at least a segment of the number, and displaying the number in a display device. Besides, the present invention provides a device for concealing at least a mark in the number displayed.

### FIELD OF THE INVENTION

The present invention relates to a method and its device for concealing marks in numbers and particularly to a method and its device for concealing a mark in the segments of a number, offering users with convenient observation and operation.

### BACKGROUND OF THE INVENTION

In the popular number puzzle Sudoku, for example, the number from 1 to 9 are filled into a 3×3 block with the restriction that each number can only appear once in every row and column. However, numbers displayed in the conventional number puzzle device do not have any marking function. Users can fill one possible number into one of the empty blocks, and if the number filled is incorrect, a number has to be filled in again until it is correct. In this way, pen and paper are necessary to record the numbers which have already been tried to avoid a number being filled twice, causing inconvenience to users.

### SUMMARY OF THE INVENTION

To solve the shortcoming of the prior art described above, it is an object of the present invention to provide a method for concealing at least a mark in a number, in which at least a mark can be concealed in the segments of the number, offering users with convenient observation and operation.

To solve the shortcoming of the prior art described above, it is another object of the present invention to provide a device for concealing at least a mark in the number displayed, in which at least a mark can be concealed in the segments of the number, offering users with convenient observation and operation.

### BRIEF DESCRIPTION OF THE DRAWINGS

FIG. 1 is a flow chart of a preferred embodiment of a method for a number concealing at least a mark according to the present invention; and

FIG. 2 is a schematic illustration of a preferred embodiment of the seven segments of a number; and

FIG. 3 is block diagram of a preferred embodiment of a device for concealing at least a mark in the number displayed according to the present invention.

### DETAILED DESCRIPTION OF THE INVENTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

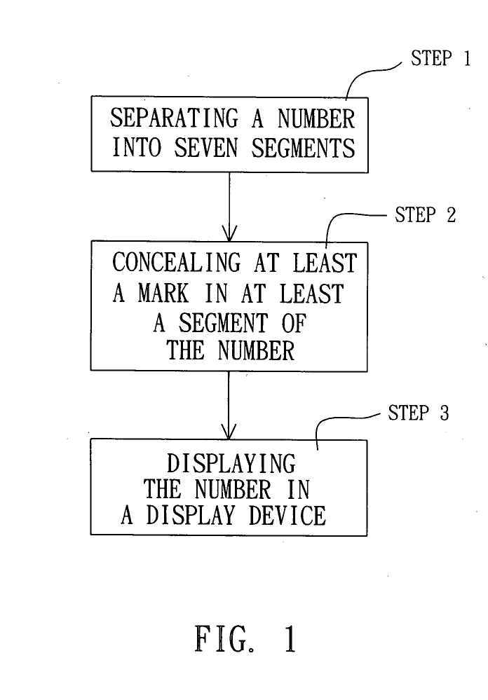

FIG. 1 is a flow chart of a method for concealing at least a mark in a number in accordance with a preferred embodiment of the present invention. Referring to FIG. 1, the method for concealing at least a mark in a number in accordance with the present invention includes the following steps: separating a number into seven segments (step 1), concealing at least a mark in at least a segment of the number (step 2), and displaying the number in a display device (step 3).

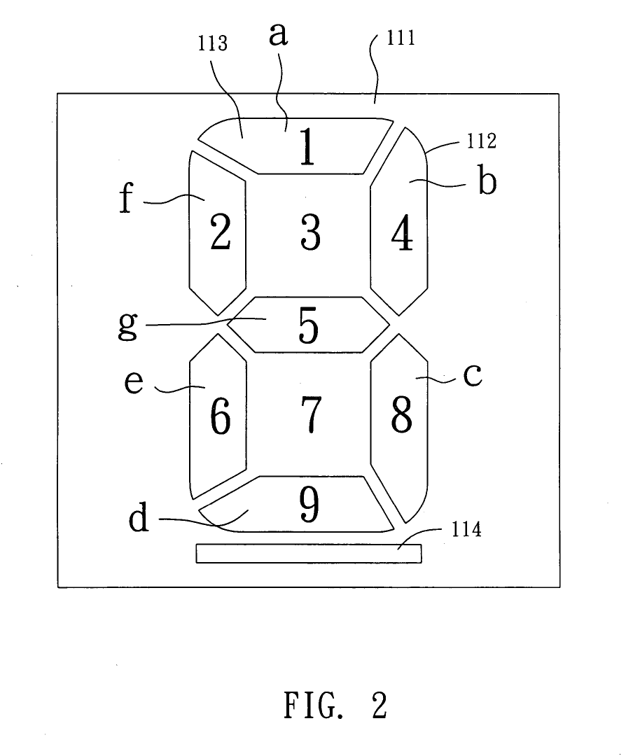

In step 1, a number 111 is separated into seven segments 112, which are a, b, c, d, e, f, and g, as shown in FIG. 2. The definitions of the segments a, b, c, d, e, f, and g are identical to those of a common seven-segment display device.

In step 2, at least a mark 113 is concealed in at least a segment of the number 111, in which the mark 113 can be an Arabic number from 1 to 9, character, symbol, and so on. In the embodiment of the present invention, the Arabic number from 1 to 9 will be used for the purpose of explanation. Also, each mark 113 concealed in the seven segments of the number is unique. For example, the mark is, but not restricted to, an Arabic number 1 in the “a” segment; the mark is, but not restricted to, an Arabic number 4 in the “b” segment; the mark is, but not restricted to, an Arabic number 8 in the “c” segment; the mark is, but not restricted to, an Arabic number 9 in the “d” segment; the mark is, but not restricted to, an Arabic number 6 in the “e” segment; the mark is, but not restricted to, an Arabic number 2 in the “f” segment; the mark is, but not restricted to, an Arabic number 5 in the “g” segment; the mark is, but not restricted to, an Arabic number 3 in the space encircled by the “a”, “b”, “f”, and “g” segments; and the mark is, but not restricted to, an Arabic number 7 in the space encircled by the “c”, “d”, “e”, and “g” segments. Besides, there is a further optional segment 114 under the number 111 to provide an optional function for users during the game.

In step 3, the number is displayed in a display device, which is a liquid crystal display device for a preferred embodiment of the present invention.

Consequently, with the help of the present method, at most 9 marks 113 can be added in the seven segments 112 of the seven-segment number 111, offering users a way to input the number 111 into a block accordingly when playing number puzzles. When users input the number 1, for example, the “a” segment will be displayed and the “a” segment has the mark of 1 to remind users. When users input the number 2, for example, the “f” segment will be displayed and the “f” segment has the mark of 2. By analogy, when users input the number 9, the “d” segment will be displayed and the “d” segment has the mark of 9. Consequently, users can get rid of the trouble of writing down numbers as a reminder.

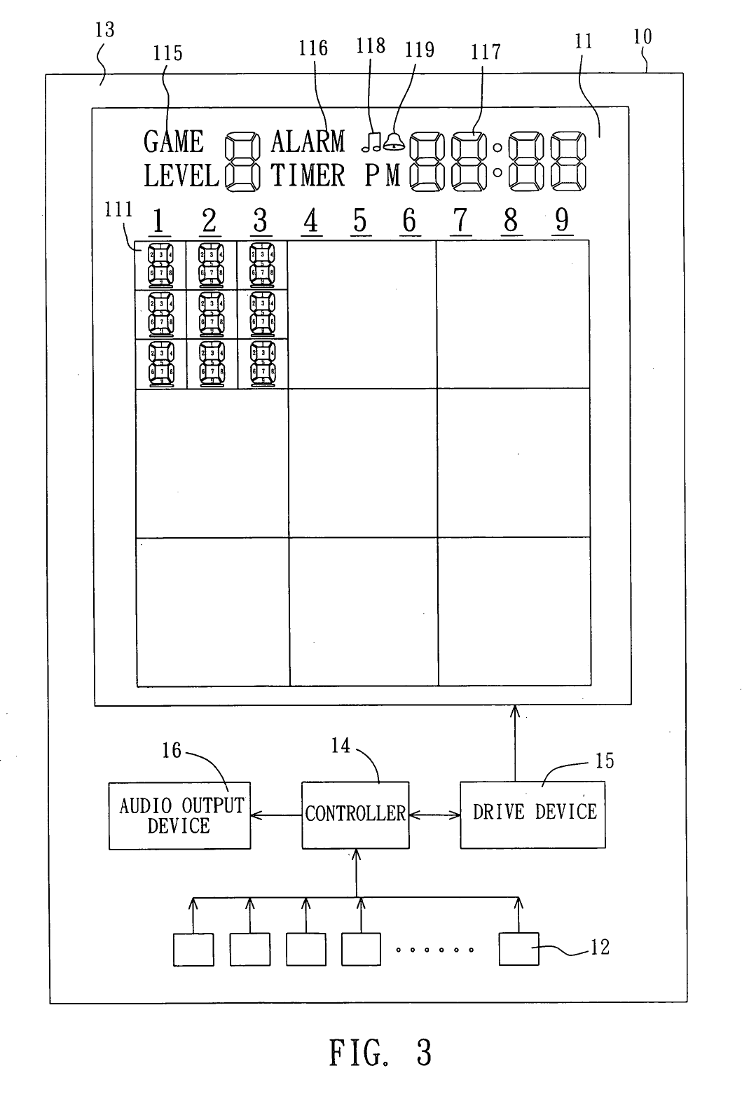

Furthermore, the present invention also discloses a device for concealing at least a mark in the number displayed. FIG. 3 is a block diagram of a device for concealing at least a mark in the number displayed in accordance with a preferred embodiment of the present invention. Referring to FIG. 3, the device 10 for at least a mark is concealed in the number displayed according to the present invention includes a display device 11, at least an input key 12, a printed circuit board 13, a controller 14, a drive device 15, and an audio output device 16.

The display device 11 is a liquid crystal display which can display at least a seven-segment number 111 and one of the seven segments 112 is provided with at least a mark 113. For example, the mark 113 is, but not restricted to, an Arabic number from 1 to 9, character, symbol, and so on. Also, each mark 113 concealed in the seven segments 112 of the number 111 is unique. The seven segments 112 of the number 111 are a, b, c, d, e, f, and g. The definitions of the segments a, b, c, d, e, f, and g are identical to those of a common seven-segment display device.

For example, the “a” segment 112 of the seven-segment number 111 has, but not restricted to, the mark of an Arabic number 1; for example, the “b” segment 112 has, but not restricted to, the mark of an Arabic number 4; for example, the “c” segment 112 has, but not restricted to, the mark of an Arabic number 8; for example, the “d” segment 112 has, but not restricted to, the mark of an Arabic number 9; for example, the “e” segment 112 has, but not restricted to, the mark of an Arabic number 6; for example, the “f” segment 112 has, but not restricted to, the mark of an Arabic number 2; for example, the “g” segment 112 has, but not restricted to, the mark of an Arabic number 5; for example, the space encircled by the “a”, “b”, “f”, and “g” segments 112 has, but not restricted to, the mark of Arabic number 3; for example, the space encircled by the “c”, “d”, “e”, and “g” segments 112 has, but not restricted to, the mark of an Arabic number 7. Consequently, with the help of the present invention, the seven segments 112 of the seven-segment number 111 have 9 different marks 113. Besides, there is a further optional segment 114 under the number 111 to provide an option function for users during the game. In a number puzzle, for example, the numbers in a 3×3 block are a question and then the optional segment 114 will not be displayed. If it is an empty block which a number can be filled in by users, the optional segment 114 will be displayed as a reminder for users.

Users can use the input key 12 for input, selection, or operation; for example, reset and start a game, input a mark into the segment 112, turn on or turn off power, and so on.

The printed circuit board 13 is to hold the controller 14, the drive device 15, and others.

The controller 14 provided on the printed circuit board 13 and coupled with the input key 12 to is receive instructions from the input key 12 and in turn to execute related instructions.

The drive device 15 provided on the printed circuit board 13 and coupled with the controller 14 is to drive the display device 11 and in turn to display the number 111.

The audio output device 16 is, for example, but not restricted to, a speaker, coupled with the controller 14 to receive instructions from the controller 14 and in turn to output audio signals.

Also, the display device 11 can further display characters or numbers, including game level 115, alarm 116, time (88:88) 117, tone 118, and alert sound 119.

Moreover, the device 10 for concealing at least a mark in the number displayed according to the present invention is provided with a key (not shown) with executing functions. When the key is pressed down, the controller 14 will check if the numbers in every row and column are repeated. If the numbers are repeated, the audio output device 16 will signal alert sounds to remind users to re-input numbers.

Moreover, the device 10 for concealing at least a mark in the number displayed according to the present invention is provided with a case (not shown) to accommodate and protect the devices described above.

Consequently, the device 10 for concealing at least a mark in the number displayed according to the present invention can, provide users with convenience in observation and operation and therefore improve the conventional device of number puzzles.

While the invention has been described with reference to the a preferred embodiment thereof, it is to be understood that modifications or variations may be easily made without departing from the spirit of this invention, which is defined by the appended claims.

What is claimed is:

1. A method for concealing at least a mark in a number, comprising:
separating a number into seven segments;
concealing at least a mark in at least a segment of the number; and
displaying the number in a display device.

2. The method of claim 1, wherein the seven segments of the number are a, b, c, d, e, f, and g, and the definitions of the segments a, b, c, d, e, f, and g are identical to those of a common seven-segment display device.

3. The method of claim 8, wherein each mark concealed in the seven segments of the number is unique.

4. The method of claim 2, wherein the mark can be an Arabic number from 1 to 9, character, symbol, and so on.

5. The method of claim 4, wherein the mark is an Arabic number 1 in the “a” segment; the mark is an Arabic number 4 in the “b” segment; the mark is an Arabic number 8 in the “c” segment; the mark is an Arabic number 9 in the “d” segment; the mark is an Arabic number 6 in the “e” segment; the mark is an Arabic number 2 in the “f” segment; the mark is an Arabic number 5 in the “g” segment; the mark is an Arabic number 3 in the space encircled by the “a”, “b”, “f”, and “g” segments; and the mark is an Arabic number 7 in the space encircled by the “c”, “d”, “e”, and “g” segments.

6. The method of claim 1, wherein there is a further optional segment under the number.

7. The method of claim 1, wherein the display device is a liquid crystal display.

8. A device for concealing at least a mark in the number displayed, comprising:
a display device, capable of displaying at least a seven-segment number in which one of the seven segments is provided with at least a mark;
at least an input key, for users to conduct input, selection, or operation;
a printed circuit board, holding the devices described below;
a controller, provided on the printed circuit board and coupled with the input key to receive instructions from the input key to execute related instructions;
a drive device, provided on the printed circuit board and coupled with the controller to drive the display device and in turn to display the number; and
an audio output device, provided on the printed circuit board and coupled with the controller to receive instructions from the controller and in turn to output audio signals.

9. The device of claim 8, wherein the seven segments of the number are a, b, c, d, e, f, and g, and the definitions of the segments a, b, c, d, e, f, and g are identical to those of a common seven-segment display device.

10. The device of claim 8, wherein each mark concealed in the seven segments of the number is unique.

11. The device of claim 10, wherein the mark can be an Arabic number from 1 to 9, character, symbol, and so on.

12. The device of claim 11, wherein the “a” segment of the seven-segment number has the mark of an Arabic number 1; the “b” segment has the mark of an Arabic number 4; the “c” segment has the mark of an Arabic number 8; the “d” segment has the mark of an Arabic number 9; the “e” segment has the mark of an Arabic number 6; the “f” segment has the mark of an Arabic number 2; the “g” segment has the mark of an Arabic number 5; the space encircled by the “a”, “b”, “f”, and “g” segments has the mark of Arabic number 3; the space encircled by the “c”, “d”, “e”, and “g” segments has the mark of an Arabic number 7.

13. The device of claim 12, wherein there is a further optional segment under the number.

14. The device of claim 8, wherein the display device is a liquid crystal display.

15. The device of claim 8, wherein the display device can further display characters or numbers, including game level, alarm, time, tone, or alert sound.

16. The device of claim 8, wherein a case is provided to accommodate and protect the device.

17. The device of claim 8, wherein a key is further provided with executing functions and when the key is pressed down, the controller will check if the numbers in every row and column are repeated and if the numbers are repeated, the audio output device will signal alert sounds to remind users to re-input numbers.
